(19) United States
(12) Patent Application Publication
(10) Pub. No.: US 2011/0171613 A1
(43) Pub. Date: Jul. 14, 2011

(54) Sculptigami-manipulative sculpture

(76) Inventor: Thomas K. Burks, Cathedral City, CA (US)

(21) Appl. No.: 12/657,123

(22) Filed: Jan. 13, 2010

(51) Int. Cl. G09B 19/00

(52) U.S. Cl. 434/82

(57) ABSTRACT

A square, flat sheet of flexible, plastic material onto which 12 predetermined, scored fold-lines are administered so that the device can be manipulated and folded to create numerous sculptural forms and shapes, repeatedly.

### FEDERALLY SPONSORED RESEARCH

Not Applicable

### SEQUENCE LISTING OR PROGRAM

Not Applicable

### BACKGROUND

1. Field of Invention

This new use/new process invention relates loosely to the ancient Japanese art form of origami, in that its forms, designs, and sculptural outcomes result from folds in a square, flat sheet of material.

2. Description of Prior Art

Traditional origami (the ancient Japanese art of paper folding) begins with a square piece of paper that is folded carefully to result in a single design or shape. Practitioners meticulously fold each crease with care and pride, taking the art form to an almost therapeutic level. Hours can be spent in order to produce one single design.

With most folding-art inventions, once they are folded, they are rendered and finished; you cannot unfold them to make another shape. Greeting cards, ornaments, toys, and utilitarian uses of pre-determined folds in different types of materials that result in tents, containers, envelopes and the like are limited to their single design. Origami-style inventions, by their sheer nature, are designed to result in a single, predetermined shape.

Olson, with his U.S. Pat. No. 6,248,426 (2001), proposes sheets of construction paper that include pre-printed fold lines that will help the beginning origami artist. This invention is not much different than traditional origami, where each sheet is used for one design; once folded, it cannot be used again for another shape. Stern's Balancing Ornament, U.S. Pat. No. 5,932,303 (1999), is of paper and its final outcome is a bird, a single shape. In 1997, Au patented an origami ornament (U.S. Pat. No. D387, 003) that results, again, in one single shape. More utilitarian uses of origami were patented by Brewster with U.S. Pat. No. 5,641,115 (1997) with greeting cards and envelopes, and by Remer with U.S. Pat. No. 5,842,630 (1998) with pre-creased materials that resulted in tent-like structures, used for shelter. Both of these resulted in single, pre-determined shapes.

The overriding weaknesses of these prior inventions are two-fold:

a) They are limited in their scopes in that each prior art results in a single, pre-determined outcome. All of the creativity in the above inventions was done by the inventor and leaves no creativity for the user of the invention.

b) Another limiting concern is the fact that each of the above inventions can be used only once. Even Olson's pre-printed construction paper is used only once, not to be re-used or reshaped. This is a valid environmental concern, as this paper is folded and tossed out.

### OBJECTS AND ADVANTAGES

There are several objects and advantages to Sculptigami, my present invention. They will:

a) permit users to create multiple shapes, multiple times from a single product;

b) permit users to create multiple shapes without having to fold a single crease;

c) eliminate the stress of having to follow intricate diagrams and directions inherent in traditional origami books;

d) open the doors of creativity to people of all ages;

e) allow the feeling of original, discovered creativity;

f) enable manufacturers to produce a product of different sizes, colors, and patterned prints;

g) permit consumers the option of buying a product made of recycled materials (old tires, tubes, milk cartons, etc.);

h) provide access of manipulative therapy to victims of stroke, Parkinson's disease,

i) provide educational opportunities to children's discovery museums, math and art classes, and senior center.

j) provide a self-motivating toy for car trips.

Further objects and advantages will be explored later, in the “Ramifications” section of this application. Additional objects and advantages will be apparent in the viewing of drawings, descriptions, and photos that will ensue.

### SUMMARY

In accordance with this present invention a device of recycled, flexible, scored material which can be manipulated repeatedly into numerous and distinct sculptural designs for the purposes of manipulative therapy, education, entertainment, and creative relaxation.

### DRAWINGS

### Drawing Figures

In the drawings, the scored lines of the finished product will be referred to as “folds.” The individual drawings will be numbered and the folds within those drawings will be lettered so as to limit confusion.

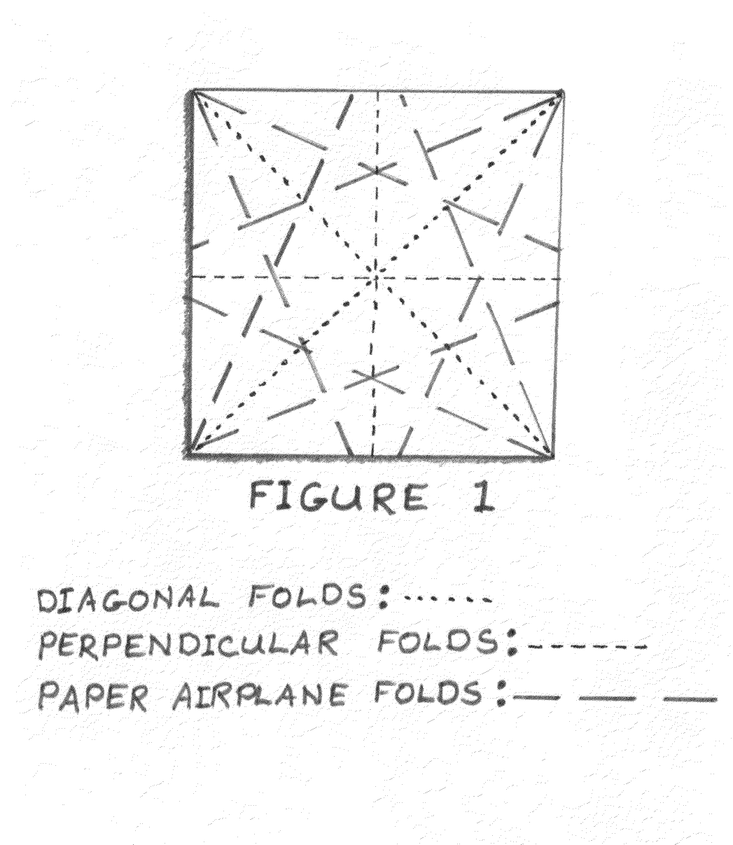

FIG. 1 shows all twelve folds on the square device.

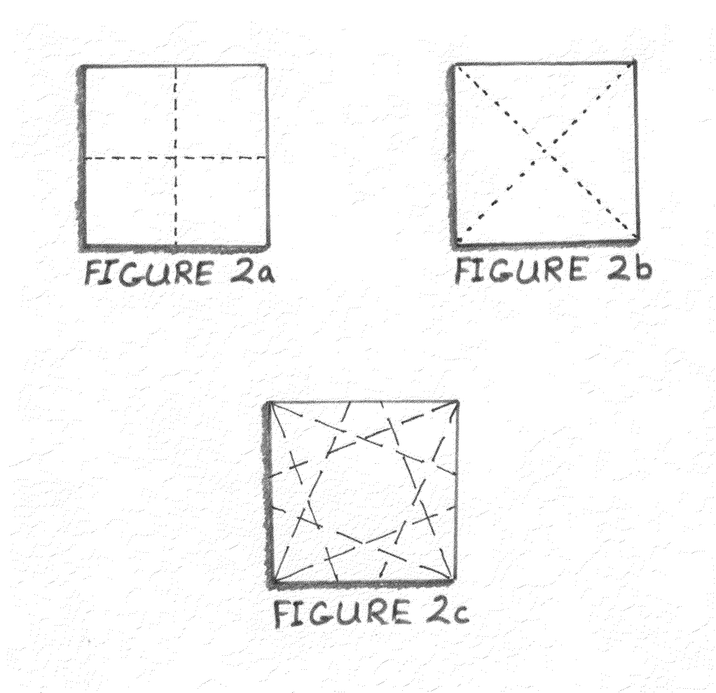

FIGS. 2a, 2b, and 2c delineate the individual folds.

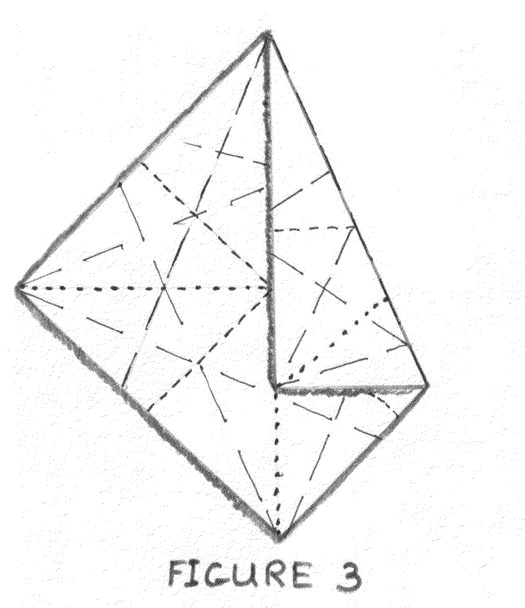

FIG. 3 shows an example of the “paper airplane” fold.

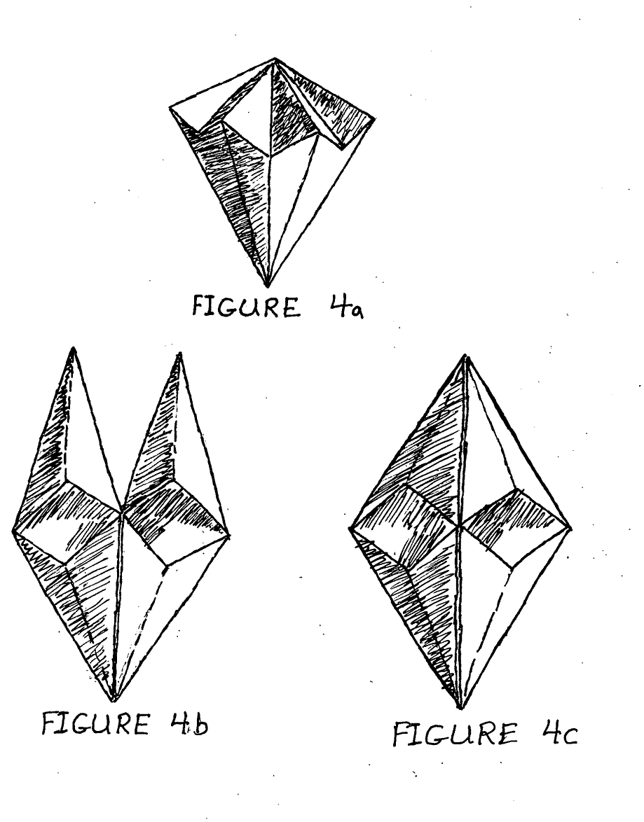

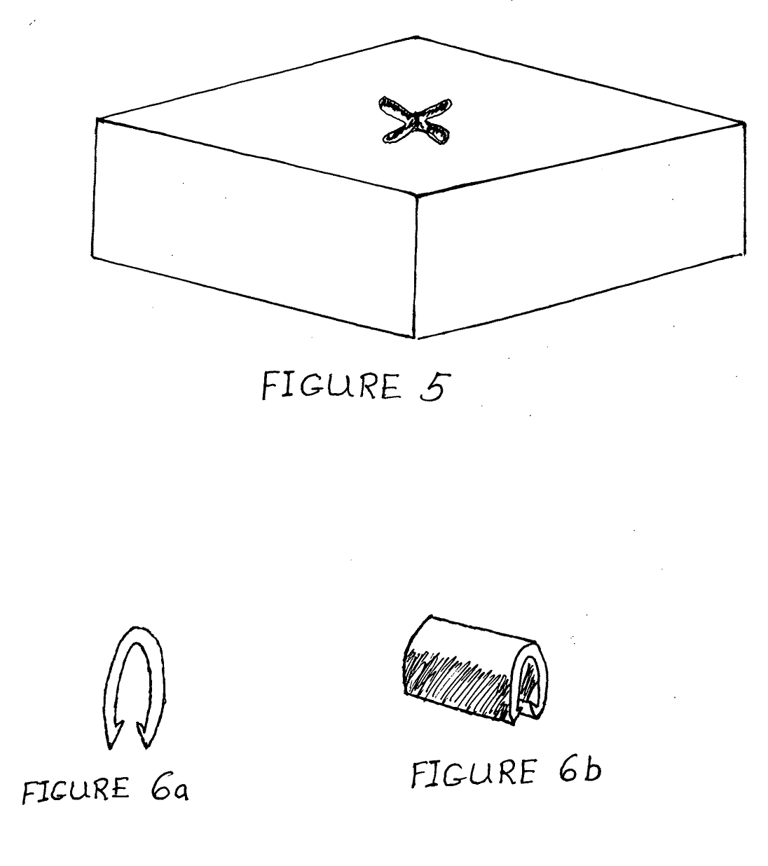

FIGS. 4a, 4b, and 4c show three of the original designs: “Diamond,” “Batman,” and “Spiderman.”

FIG. 5 shows a possible example of the modeling base, or stand, on which to display the different shapes.

FIG. 6 shows the clip that may hold sculptural shapes together temporarily. (6a is a side view; 6b is an end view.) Photos will be utilized to show the numerous sculptural shapes that ensued.

### REFERENCE LETTERS IN DRAWINGS

A—Perpendicular folds

B—Diagonal folds

C—Paper Airplane folds

### DETAILED DESCRIPTION

FIG. 1

This figure shows all twelve folds (which are scored lines in the product). FIG. 1 details each fold type, delineating each type with different hash marks. The perpendiculars (A) are short dashes; the diagonals (B) are dots; and the paper airplane folds (C) are longer, bolder dashes.

FIGS. 2a-2c

These three figures effectively separate each fold type. FIG. 2a shows the perpendicular folds (A), basically two folds that halve the square product into rectangular shapes, the folds intersecting at the products center.

FIG. 2b shows the diagonal folds (B), two folds that halve the square product into triangular shapes and intersect at the product's center.

FIG. 2c shows the paper airplane folds (C), eight folds that individually originate at each corner of the product and permit the folded sides to meet along a center, diagonal (B) fold.

FIG. 3

FIG. 3 shows a dynamic representation of the paper airplane folds (C). FIG. 3 shows an unfolded paper airplane fold and a folded paper airplane fold. When both are folded inward the sides meet along the pictured diagonal fold (B).

FIGS. 4a-4c

FIG. 4a is a drawing of the original diamond shape. (When I was first shown the twelve folds, years ago, this was the shape for which they were intended. For many years this was the only sculptural shape that ever came out of the folds. It was only after my 5-year-old nephew experimented with the diamond and came up with his “Batman” and “Spiderman” shapes did I begin to experiment and discover numerous shape possibilities.)

FIG. 4b shows Justin's “Batman” sculpture.

FIG. 4c shows Justin's “Spiderman” sculpture.

Photos

The photos show many of the sculptural shapes that result from the twelve folds. It would be impossible to show every possible shape in this application because I believe that the possibilities are huge in number. The examples in these photos illustrate the versatility of the product and its vast potential as a beneficial tool (manipulative therapies, math, art, and architectural applications, discovery, etc.) and an exotic toy (executive, recreational, child, etc.) (See “Ramifications.”)

### ADVANTAGES

After viewing the figures and photos, one can realize many advantages over traditional, existing origami art forms:

a) Numerous shapes can be realized from a single product.

b) Users do not have to follow confusing, detailed folding instructions.

c) Product can be used and reused, making for a very environmentally friendly tool and toy.

d) Shapes range from simple to complicated, thus entertaining a wide range of consumers; regardless of talent, dexterity, experience, age, or educational level, all users can be both creative and successful.

e) The portability of the product is high. It can be carried and utilized just about anywhere: airplane, doctor's office, car trip, etc.

f) Products can be stored easily, since they can be laid flat. This is especially important when using with classrooms, therapy groups (both physical and emotional), and in retirement homes.

g) It is a time- and user-friendly device because the step of folding is eliminated; only the act of creating is utilized.

h) Since the product is of a square, flat recyclable material, it can be manufactured in any size and color and have printed upon it any logos, designs, patterns, company names, pictures, cartoons, and other thematic images that will, when the product is manipulated into the various shapes, create unique optical effects.

### OPERATION

The act of creating sculptural shapes with this device is similar to the traditional origami shaping of square sheets of paper, with two major differences being the facts that actual folding, the creating of scored lines, is eliminated in this new device, as is the following of written/illustrated, step-by-step directions. Both of these eliminations make this new device unique and separate from traditional origami.

The device is a discovery tool, in that the user folds and manipulates said device into unique, creative shapes. By folding along the scored lines in different manners, directions, and orientations, the user will realize multitudes of sculptural shapes, both symmetrical and asymmetrical. The actual operation of this device is difficult to nail down in that it demands user creativeness and “thinking outside the envelope” when it comes to manipulation. In other words, there are no “right” or “wrong” ways to use this device. To apply rules and methods would be to limit its benefits, possibilities, and outcomes.

The scored lines are applied to said device in a fashion that facilitates folding in either direction, front or back, and the flexible material further facilitates unique directional folding.

The clips, which will be included with each device, are designed to hold edges of the said device together so that discovered shapes may be temporarily preserved, to be shared and displayed by the user. Used like paper clips but functioning like old-style clothespins, these small plastic clips can also be used to enhance “finished” sculptural shapes by holding down corners or sides to create variations in structure.

The clips simply slide over two edges to hold them together.

A base, or stand, is included with each device. Said base is used to display preserved sculptural shapes. An X-shaped cut in the top of the box-like, plastic/rubber base holds sculptural products upright when they are inserted.

### CONCLUSIONS, RAMIFICATIONS, AND SCOPE

As you can see, this current invention offers the user far more creative license than do traditional origami applications. As stated above, origami art pieces result in a single shape or figure and then is rendered and complete; this invention results in unlimited sculptural shapes and can be used and reused, shaped and reshaped, many times. Furthermore, origami necessitates the following of directions and the tedious acts of folding and scoring; this invention does not, and it allows the user a feeling of original, discovered creativity and artistry.

The ramifications and scope of this invention are numerous, and many of them may be yet undiscovered and unrealized. Ramifications which have been explored are as follows:

a) It can be used as manipulative therapy for stroke patients, trauma patients, the elderly, and victims of Parkinson's disease.

b) It can be used as an educational tool in math classes from Kindergarten to university levels to teach geometry, symmetry, area, and mass.

c) It can be used as an educational tool in art and architectural classes to help students grasp concepts of sculpting, form, and structure.

d) It can be used as a discovery toy for children.

e) It can be used as interesting hands-on exhibits at the popular children's discovery museums.

f) It can be beneficial in retirement and rehabilitation homes.

g) It can be utilized in the waiting rooms of doctors, lawyers, and other executives for the amusement of their clients.

h) It can be used as an executive's exotic toy.

k) It makes a great gift option.

l) It can create Christmas decorations such as ornaments and centerpieces and other thematic, holiday-specific designs.

m) Further conceptions and refinements of this invention include:
1) opportunities to manufacture individual devices in different colors;
2) opportunities to have etched or printed designs, logos, pictures, likenesses, scenes, cartoons, or other thematic images that could encourage buyers to collect them (much like mouse pads);
3) opportunities to manufacture in different sizes, so as to enhance the device's portability;
4) a book of photographed possible shapes and sculptures previously created by past users to challenge current users to copy.

Sculptigami (as I have named this invention) can be used by any aged person and is time- and user-friendly in that the laborious act of folding is eliminated, leaving just the act of creating. Though the scored fold-lines are static (in that they cannot be changed), Sculptigami can be manipulated into a seemingly unlimited number of shapes, sculptures, and forms.

I claim:

1. A device of flexible, scored material which can be manipulated into numerous and distinct sculptural designs for the purposes of therapy, entertainment, education, relaxation, and aesthetics.

2. The device of claim 1 is flat and square in dimension and shape, respectively.

3. The device of claim 1 is made of a soft and pliable vinyl/plastic-type material.

4. The material of claim 3 can have printed upon it different colors patterns.

5. The device of claim 1 is scored along predetermined fold-lines.

6. The fold-lines of claim 5 are scored two-sided so as to bend and fold freely in both directions: front and back.

7. The fold lines of claim 5 are 12 in number:
a) Two crossed diagonals, corners to corners, halving said device into triangles;
b) Two crossed perpendiculars, sides to sides, halving said device into rectangles;
c) Eight “ paper airplane” folds (for want of a better term), two at each corner, which bring the sides in to meet a centerline.

8. The device of claim 1 has potential for numerous sculptural designs.

9. The designs of claim 8 are achieved by the manifestations of different combinations of folds at the scored lines.

10. The number of different designs of claim 8 discovered by the inventor has reached over 200.

11. The potential for the sheer number of different combinations of claim 8 are multiple and seemingly unlimited.

12. The device of claim 1, while resulting in numerous sculptural shapes, may necessitate clips with which to hold together said sculptural shapes.

13. The clips of claim 12 are composed of rigid plastic.

14. The clips of claim 12 match the coloration and patterning of the device of claim 1.

15. The clips of claim 12 are of a simple U-shape, incorporating serrated “teeth” near the open end that will hold the device's edges together.

16. The device of claim 1, while resulting in numerous sculptural shapes, may necessitate a base, or stand, on which to display the temporary, clipped sculptural designs.

17. The base of claim 16 is composed of soft, pliable plastic/vinyl/rubber material.

18. The base of claim 16 is box-shaped, either a cube or a three-dimensional rectangular shape.

19. The base of claim 16 has cut into its top side an X-shaped opening into which the said sculptural design can be inserted, held, and displayed.
